(19) United States
(12) Patent Application Publication
(10) Pub. No.: US 2026/0135028 A1
(43) Pub. Date: May 14, 2026

(54) COIL COMPONENT

(71) Applicant: SAMSUNG ELECTRO-MECHANICS CO., LTD., Suwon-si (KR)

(72) Inventors: Ic Seob Kim, Suwon-si (KR); Dong Gun Lee, Suwon-si (KR); Joung Hee Cho, Suwon-si (KR); Sang Hyeon Hong, Suwon-si (KR); Dong Hwi Ahn, Suwon-si (KR); Jin Hyuck Yang, Suwon-si (KR)

(73) Assignee: SAMSUNG ELECTRO-MECHANICS CO., LTD., Suwon-si (KR)

(21) Appl. No.: 19/253,303

(22) Filed: Jun. 27, 2025

(30) Foreign Application Priority Data
Nov. 11, 2024 (KR) 10-2024-0159160

(51) Int. Cl. H01F 27/29; H01F 27/28

(52) U.S. Cl. CPC H01F 27/292; H01F 27/2828

(57) ABSTRACT

A coil component includes a body including first and second surfaces opposing each other in a first direction, third fourth surfaces opposing each other in a second direction, and fifth sixth surfaces opposing each other in a third direction. A recess is formed in at least one of the first, second, third, or fourth surface, and the body includes a magnetic material, a coil including a winding portion disposed within the body and a lead wire at least partially disposed in the recess, first and second lead frames disposed on the body and spaced apart from each other in the first direction and connected to the lead wire. A ratio ‘a/b’ is 0.042 or more and 0.502 or less in which ‘a’ is an average length of the recess in the third direction and ‘b’ is an average length of the lead frame in the third direction.

### CROSS-REFERENCE TO RELATED APPLICATION(S)

This application claims benefit of priority to Korean Patent Application No. 10-2024-0159160 filed on Nov. 11, 2024 in the Korean Intellectual Property Office, the disclosure of which is incorporated herein by reference in its entirety.

### TECHNICAL FIELD

The present disclosure relates to a coil component.

### BACKGROUND

Inductors, coil components, are representative passive electronic components used in electronic devices along with resistors and capacitors.

Recently, the market for high current power inductors for applications, such as AI, electric fields, and robots has been increased, and the importance of the efficiency of inductor devices has come to prominence, especially with the increase in the current and voltage used in electronic devices.

Medium and large power inductors include a magnetic body, coil, and lead frame. The lead frame forms an ‘L’-shaped electrode through a bending process, and it is common to form an engraving on the surface of the magnetic body on which the lead frame is disposed so that the lead frame is sunk into the magnetic body surface without a step.

### SUMMARY

An aspect of the present disclosure is to provide a coil component in which vibration resistance is enhanced and poor bonding between a lead frame and a coil is improved.

Another aspect of the present disclosure is to provide a coil component capable of easily securing bonding strength with a substrate when mounted on the substrate.

According to an aspect of the present disclosure, a coil component includes: a body including a first surface and a second surface opposing each other in a first direction, a third surface and a fourth surface opposing each other in a second direction, and a fifth surface and a sixth surface opposing each other in a third direction, in which at least one recess is formed in at least one of the first, second, third, or fourth surface, and the body includes a magnetic material; a coil including a winding portion disposed within the body and at least one lead wire at least partially disposed in the at least one recess; first and second lead frames disposed on the body and spaced apart from each other in the first direction and connected to the at least one lead wire. A ratio ‘a/b’ is 0.042 or more and 0.502 or less, where ‘a’ is an average length of the at least one recess in the third direction and ‘b’ is an average length of the first or second lead frame in the third direction.

According to another aspect of the present disclosure, a coil component includes: a body having at least one recess formed in one surface thereof and including a magnetic material; a coil including a winding portion disposed within the body and a lead wire at least partially disposed in the at least one recess; and at least one lead frame disposed on the one surface of the body and including an internal surface in contact with the lead wire and an external surface opposing the internal surface. The internal surface of the at least one lead frame is coplanar with the one surface of the body or is located outside the body.

According to still another aspect of the present disclosure, a coil component includes: a body including a magnetic material, the body including a first surface and a second surface opposing each other in a first direction, a third surface and a fourth surface opposing each other in a second direction, and a fifth surface and a sixth surface opposing each other in a third direction, wherein a first recess is formed on the first and third surfaces and a second recess is formed on the second and third surfaces; a coil including a winding portion disposed within the body, and first and second lead wires extending from opposing ends of the winding portion in the first direction, bent and extending along the first and second recesses, respectively; first and second lead frames disposed on the body, spaced apart from each other in the first direction and surface contacting outer surfaces of the first and second lead wires disposed in the first and second recesses, respectively. At least a portion of the first lead frame is disposed outside of the first surface, which is an outermost surface of the body, and at least a portion of the second lead frame is disposed outside of the second surface, which is another outermost surface of the body

### BRIEF DESCRIPTION OF DRAWINGS

The other aspects, features, and advantages of the present disclosure will be more clearly understood from the following detailed description, taken in conjunction with the accompanying drawings, in which:

FIG. 1 is a perspective view illustrating a coil component according to a first embodiment of the present disclosure;

FIG. 2 is a view illustrating a lead frame and lead wire of FIG. 1;

FIG. 3 is a perspective view illustrating a body of FIG. 1 before bending the lead frame;

FIG. 4 is a view illustrating the coil component of FIG. 1 viewed in a Z-direction;

FIG. 5 is a cross-sectional view taken along line I-I′ of FIG. 1;

FIG. 6 is a perspective view illustrating a coil component according to the second embodiment of the present disclosure;

FIG. 7 is a perspective view illustrating a body of FIG. 6;

FIG. 8 is a view illustrating the coil component of FIG. 6 viewed in the Z-direction;

FIG. 9 is a cross-sectional view taken along line II-II′ of FIG. 6;

FIG. 10 is a view illustrating a modified example of FIG. 8;

FIG. 11 is a perspective view illustrating a coil component according to a third embodiment of the present disclosure;

FIG. 12 is a view illustrating the coil component of FIG. 11 viewed in the Z-direction;

FIG. 13 is a view illustrating a modified example of FIG. 11; and

FIG. 14 is a view illustrating another modified example of FIG. 11.

### DETAILED DESCRIPTION

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

The terms used in the present specification are merely used to describe particular embodiments and are not intended to limit the present disclosure. An expression used in the singular encompasses the expression of the plural, unless it has a clearly different meaning in the context. In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

In addition, coupling does not mean only the case of direct physical contact between each component in a contact relationship, but it should be used as a concept encompassing even a case in which another component intervenes between each component so that a component is in contact with the other component.

Since the size and thickness of each component illustrated in the drawings are arbitrarily illustrated for convenience of description, the present disclosure is not necessarily limited to the illustrated.

In the drawings, an X-direction may be defined as a first direction or length direction, a Y-direction may be defined as a second direction or width direction, and a Z-direction may be defined as a third direction or thickness direction.

Hereinafter, a coil component according to an embodiment in the present disclosure will be described in detail with reference to the accompanying drawings, and in the description with reference to the accompanying drawings, the same or corresponding components are assigned the same reference numerals and overlapping descriptions thereof will be omitted.

Various types of electronic components are used in electronic devices, and various types of coil components may be appropriately used between these electronic components for the purpose of removing noise.

That is, in electronic devices, coil components may be used as power inductors, high-frequency (HF) inductors, general beads, GHz beads, common mode filters, etc.

### First Embodiment

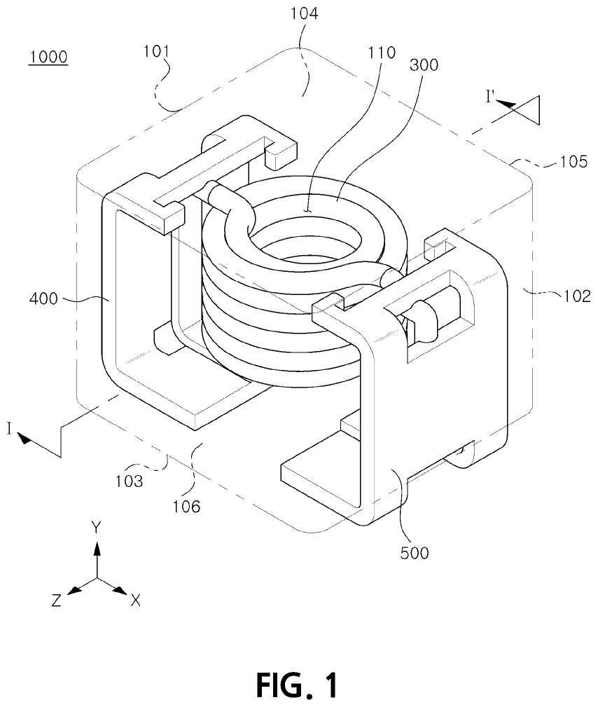

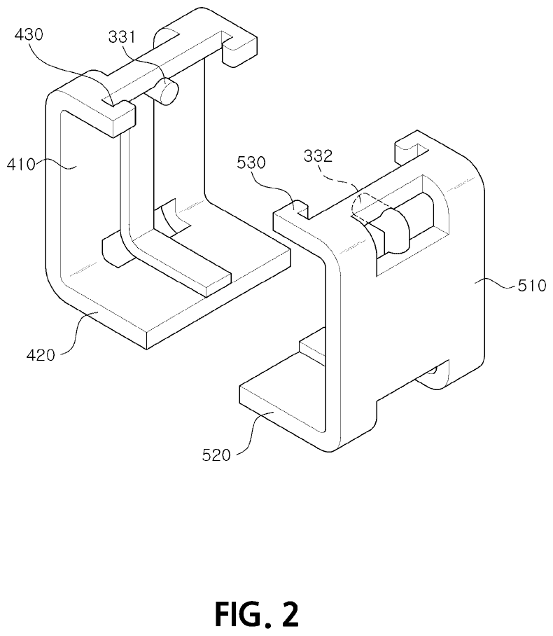

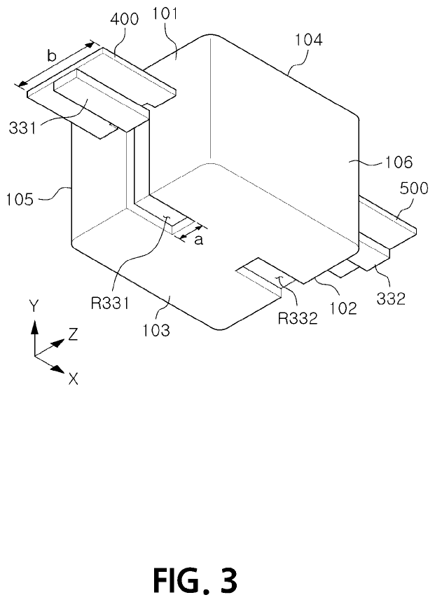

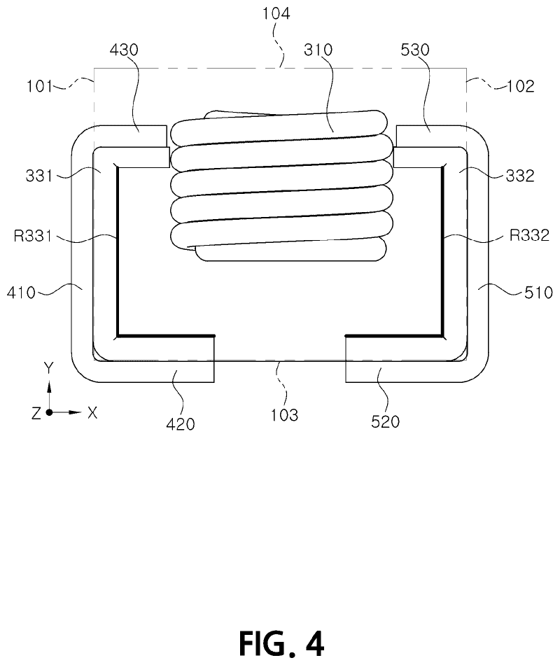

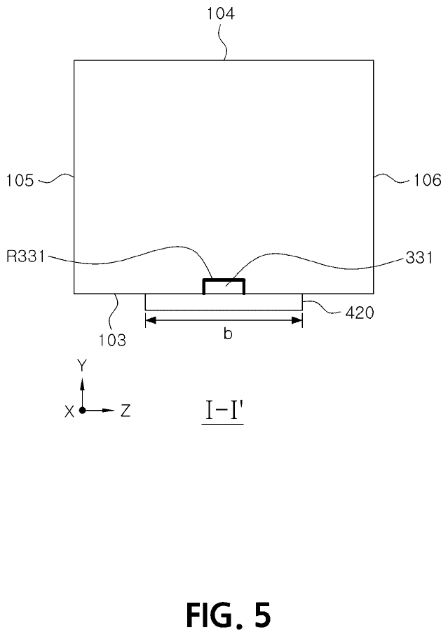

FIG. 1 is a perspective view illustrating a coil component according to a first embodiment of the present disclosure. FIG. 2 is a view illustrating a lead frame and lead wire of FIG. 1. FIG. 3 is a perspective view illustrating a body of FIG. 1 before bending the lead frame. FIG. 4 is a view illustrating the coil component of FIG. 1 viewed in a Z-direction. FIG. 5 is a cross-sectional view taken along line I-I′ of FIG. 1.

Referring to FIG. 1, a coil component 1000 according to an embodiment of the present disclosure includes a body 100 including a magnetic material, a coil 300 disposed within the body 100, and lead frames 400 and 500 disposed on the body 100 and spaced apart from each other in the first direction.

The body 100 forms the external casing of the coil component 1000 according to the present embodiment, and the coil 300 is embedded therein.

The body 100 may be formed in an overall hexahedral shape. Referring to FIG. 1, the body 100 includes a first surface 101 and a second surface 102 opposing each other in the first direction (the X-direction), a third surface 103 and a fourth surface 104 opposing each other in the second direction (the Y-direction), and a fifth surface 105 and a sixth surface 106 opposing each other in the third direction (the Z-direction). Each of the first surface 101, the second surface 102, the fifth surface 105, and the sixth surface 106 of the body 100 corresponds to a side surface of the body 100 connecting the third surface 103 and the fourth surface 104 of the body 100. The body 100 may be formed such that the coil component 1000 according to the present embodiment, in which the lead frames 400 and 500 to be described below are formed, has a length of 4.0 mm and a width of 4.0 mm, a length of 5.0 mm and a width of 5.0 mm, a length of 6.0 mm and a width of 6.0 mm, and a length of 13.0 mm and a width of 13.0 mm, but is not limited thereto. The size of the coil component 1000 according to the present embodiment described above is merely an example, and therefore, a case formed to a size other than the aforementioned sizes is not excluded from the scope of the present disclosure.

A recess R is formed on at least one of the first to fourth surfaces 101, 102, 103, and 104 of the body 100. The recess R may accommodate lead wires 331 and 332 of the coil 300 to be described below. Meanwhile, the recess R may not accommodate lead frames 400 and 500 to be described below.

The lead frames 400 and 500 are bent downward from a side surface of the body 100, and here, the bent lead frame is generally accommodated in a recess formed in the external surface of the body with a certain width and depth. However, in this case, the volume of a magnetic body may be reduced by the volume of the recess formed in the external surface of the body, which may lead to a deterioration of electrical characteristics of the coil component, such as inductance and Isat.

Meanwhile, the coil component 1000 according to the present embodiment may minimize magnetic loss by forming the recess R having a size sufficient to accommodate the lead wires 331 and 332 of the coil 300 on the external surface of the body.

The recess R may be sunken inward from the external surface of the body. Referring to FIG. 3, the recess R may include a bottom surface parallel to the external surfaces 101, 102, and 103 of the body and both side surfaces connecting the external surfaces 101, 102, and 103 and the bottom surface.

A length (width a) of the recess R in the third direction (the Z-direction) may be 0.21 mm or more and 2.51 mm or less. As described below, the width a of the recess R may be less than a width b of the lead frames 400 and 500. By forming the recess R having the width a less than the width b of the lead frames 400 and 500 on the external surface of the body, magnetic loss may be minimized and the electrical characteristics of the coil component may be improved.

The depth of the recess R may be 0.2 mm or less. The depth of the recess R may be substantially the same as the thickness of the lead wires 331 and 332.

The recess R may include a first recess R331 and a second recess R332 spaced apart from each other in the first direction (the X-direction) on the third surface 103 of the body. At least a portion of the first lead wire 331 to be described below may be disposed in the first recess R331. Similarly, at least a portion of the second lead wire 332 to be described below may be disposed in the second recess R332.

The first recess R331 may be formed on the first surface 101 of the body. The first recess R331 may extend from the third surface 103 of the body to the first surface 101 to form an ‘L’ shape. Similarly, the second recess R332 may be formed on the second surface 102 of the body. The second recess R332 may extend to the second surface 102 of the body to form an ‘L’ shape.

The body 100 may include a magnetic material. The body 100 may be formed by filling a mold with a magnetic material or may be formed by filling a mold with a composite material including a magnetic material and an insulating resin. A molding process of applying high temperature and high pressure to the magnetic material or composite material in the mold may be additionally performed, but is not limited thereto.

The magnetic material included in the body 100 may be, for example, ferrite or magnetic metal powder particles.

The ferrite powder particle may be, for example, at least one of spinel-type ferrites, such as Mg—Zn-based, Mn—Zn-based, Mn—Mg-based, Cu—Zn-based, Mg—Mn—Sr-based, Ni—Zn-based ferrites, hexagonal ferrites, such as Ba—Zn-based, and Ba—Mg-based, Ba—Ni-based, Ba—Co-based, and Ba—Ni-Co-based ferrites, and a garnet-type ferrite, such as Y-based ferrite, and Li-based ferrite.

The magnetic metal powder particle may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particle may be at least one of pure iron powder particle, Fe—Si alloy powder particle, Fe—Si—Al alloy powder particle, Fe—Ni alloy powder particle, Fe—Ni—Mo alloy powder particle, Fe—Ni—Mo—Cu alloy powder particle, Fe—Co alloy powder particle, Fe—Ni—Co alloy powder particle, Fe—Cr alloy powder particle, Fe—Cr—Si alloy powder particle, Fe—Si—Cu—Nb alloy powder particle, Fe—Ni—Cr alloy powder particle, and Fe—Cr—Al alloy powder particle.

The magnetic metal powder particle may be amorphous or crystalline. For example, the magnetic metal powder particle may be an Fe—Si—B—Cr amorphous alloy powder particle, but is not necessarily limited thereto.

The ferrite and magnetic metal powder particle may each have an average diameter of about 0.1 μm to 30 μm, but is not limited thereto.

The body 100 may include two or more types of magnetic materials. Here, the different types of magnetic materials refer to that one of the diameter, composition, crystallinity, and shape of the magnetic materials is different from each other. For example, the body 100 may include two or more magnetic powder particles having different diameters.

The insulating resin may include epoxy, polyimide, liquid crystal polymer, etc. alone or in combination, but is not limited thereto.

The body 100 may include a core 110. The core 110 may refer to a portion of the body 100 penetrating through the coil 300 described below. The core 110 may be disposed in an inner region of the coil 300 forming at least one turn and may have a circular or elliptical cross-section.

The coil 300 is disposed in the body 100 and demonstrates characteristics of the coil component. For example, when the coil component 1000 according to the present embodiment is utilized as a power inductor, the coil 300 may store an electric field as a magnetic field and maintain an output voltage, thereby playing a role in stabilizing power of the electronic device.

The coil 300 may include a winding portion 310 forming at least one turn based on the core 110 and lead wires 331 and 332 connected to a lead frame to be described below.

Referring to FIGS. 1 and 5, the winding portion 310 may form a plurality of turns toward the outside of the body 100 in the first direction (the X-direction) and the third direction (the Z-direction) of the body 100 from the core 110. The winding portion 310 may be disposed parallel to the third surface 103 of the body, and a winding axis of the winding portion 310 may be formed parallel to the second direction (the Y-direction).

The winding portion 310 may be wound in a circular or oval shape as a whole, and the core 110 may be disposed in the center.

The first and second lead wires 331 and 332 are connected to both ends of the winding portion 310 and may be connected to the first and second lead frames 400 and 500, respectively.

Referring to FIG. 4, at least a portion of the first and second lead wires 331 and 332 may be disposed in the recesses R331 and R332 of the body. The first and second lead wires 331 and 332 may contact the bottom and side surfaces of the first and second recesses R331 and R332.

As described above, the first recess R331 may be formed on the first surface 101 and the third surface 103 of the body 100, and the first lead wire 331 may be disposed along the first recess R331 formed on the first surface 101 and the third surface 103 of the body 100. The second recess R332 may be formed on the second surface 102 and the third surface 103 of the body 100, and the second lead wire 332 may be disposed along the second recess R332 formed on the second surface 102 and the third surface 103 of the body 100.

The coil 300 may be an air core coil and may include a metal wire MW having a circular cross-section. The coil 300 may also include a flat coil, but is not limited thereto.

The coil 300 may be formed by winding a conductive metal, and the remaining portion of the coil 300 except for a portion in contact with the lead frames 400 and 500 described below may be coated with an insulating film. Specifically, the coil 300 may be formed by winding a metal wire MW, such as a copper (Cu) wire including a metal wire and an insulating film covering a surface of the metal wire in a spiral shape.

Referring to FIGS. 1 to 5, the lead frames 400 and 500 are disposed on the third surface 103 of the body 100 and serves as external electrodes of the coil component according to the present embodiment.

The lead frames 400 and 500 may include a first lead frame 400 disposed on the first surface 101 and the third surface 103 of the body 100 and a second lead frame 500 disposed on the second surface 102 and the third surface 103 of the body 100. The first lead frame 400 is connected to the first lead wire 331 of the body 100, and the second lead frame 500 is connected to the second lead wire 332.

Hereinafter, the description will be given based on the first lead frame 400, but the same contents may be applied to the second lead frame 500, and details may be repeated, so the description of the second lead frame 500 will be omitted.

The first lead frame 400 may include a side surface portion 410 disposed on the first surface 101 and a lower surface portion 420 disposed on the third surface 103.

The first lead frame 400 may include an internal surface and an external surface facing opposing each other. Specifically, the side surface portion 410 may include an internal surface facing the first surface 101 and an external surface facing away from the first surface 101, and the internal surface of the side surface portion 410 may be in contact with the first lead wire 331. Similarly, the lower surface portion 420 may include an internal surface facing the third surface 103 and an external surface opposing the internal surface, and the internal surface of the lower surface portion 420 may be in contact with the first lead wire 331. That is, the first lead wire 331 may be disposed inside the body 100 compared to the side surface portion 410 and the lower surface portion 420. In this manner, stress occurring on a mounting surface of a substrate may not be directly transmitted to the lead wire 331, thereby implementing a coil component having high vibration resistance.

Referring to FIGS. 4 and 5, a cross-sectional area of the first lead wire 331 may be rectangular. In addition, the first lead wire 331 may extend along the internal surface of the first lead frame 400 to the third surface 103 of the body 100. Here, since the first lead wire 331 is surface-bonded with the first lead frame 400, the lead wire and the lead frame may have a T-beam shape. Accordingly, stress applied to the lead wire 331 due to vibrations may be efficiently distributed, and a coil component having high vibration resistance may be implemented.

The first lead frame 400 may not be disposed inside the first recess R331. Referring to FIG. 5, the lower surface portion 420 of the first lead frame 400 may not be disposed in the first recess R331. Similarly, the side surface portion 410 of the first lead frame 400 may not be disposed inside the first recess R331.

Referring to FIGS. 4 and 5, the internal surface of the first lead frame 400 may be coplanar with the external surface of the body 100.

Unlike the first lead wire 331, the first lead frame 400 is not disposed in the first recess R331 of the body 100, and the lead frame protrudes compared to the external surface of the body 100. As a result, a gap may be formed between the component and the body when mounted on a substrate, and underfill for securing bonding strength of the substrate and the chip may facilitated. In addition, since it is not necessary to form the recess R331 having a size equal to the width b and thickness of the lead frame, loss of the volume of the magnetic body may be minimized.

The length (width b) of the first lead frame 400 in the third direction (the Z-direction) may be 1.8 mm or more and 5.0 mm or less.

As described above, the length (width a) of the recess R in the third direction (the Z-direction) may be 0.21 mm or more and 2.51 mm or less, so a ratio ‘a/b’ may satisfy 0.042 or more and 0.502 or less. In the ratio a/b range as described above, the volume of the magnetic body may increase by 0.8% at the least and 1.8% at the most, and electrical characteristics of the coil component may be improved. If the ratio a/b is less than 0.042, the bonding strength between the lead frame and the lead wire may weaken. If the ratio a/b exceeds 0.502, the size of the recess R may become excessively large, and loss of the volume of the magnetic body may not be minimized.

The length (width a) of the recess R in the third direction (the Z-direction) may be measured based on the recess R formed on the third surface 103 of the body 100. As shown in FIG. 3, the value a may be obtained by measuring a distance between both ends of the recess R spaced apart from each other in the third direction (the Z-direction) formed on the third surface 103 of the body 100. For example, samples may be collected from five points at equal intervals in the cross-section of the coil component in the second direction (the Y-direction)-third direction (the Z-direction). The minimum value of the lengths of the line segments parallel to the third direction (the Z-direction) connecting two outermost boundary lines of the recess R331 in each sample facing each other in the third direction (the Z-direction) may be defined as a. In addition, the value a may refer to an arithmetic mean of the lengths of the line segments in each sample.

The length (width b) of the first lead frame 400 in the third direction (the Z-direction) may be measured based on the lower surface portion 420. Specifically, the value b may be obtained by measuring the length of the lower surface portion 420 in the third direction (the Z-direction) as shown in FIG. 5.

As an example, samples may be collected from five points at equal intervals on the cross-section of the coil component in the second direction (the Y-direction)-third direction (the Z-direction). The minimum value of the lengths of the line segments parallel to the third direction (the Z-direction) connecting the two outermost boundary lines of the lower surface portion 420 facing each other in the third direction (the Z-direction) in each sample may be defined as b. In addition, the value b may refer to an arithmetic mean of the lengths of the line segments in each sample.

The lead frames 400 and 500 may further include anchor portions 430 and 530, respectively. The anchor portions 430 and 530 may be disposed inside the body 100 to enhance the fixing strength between the lead frame 400(or 500) and the body 100. In one embodiment, the anchor portions 430 and 530 may include at least one protrusion having an ‘L’ shape to further improve the fixing strength. In another embodiment, a portion of the lead wire 331 (or 332) may be disposed in an inner groove of the anchor portion of the lead frame 400 (or 500). Here, a portion of the lead wire 331 (or 332) may be further disposed in a groove formed on an internal surface of the side surface portion 410 (or 510). The first lead frame 400 may extend to the first surface 101 of the body 100 through the anchor portion 430 and may have a structure bent to the lower surface of the body 100 through the side surface portion 410 and the lower surface portion 430.

The lead frames 400 and 500 may include a metal, such as copper (Cu), silver (Ag), palladium (Pd), nickel (Ni), and the type thereof is not limited as long as it is a conductive metal. In addition, although not shown in the drawing, a metal layer may be formed on the internal and external surfaces of the lead frames 400 and 500. The metal layer is a component for bonding the lead wires 331 and 332 and the lead frames 400 and 500 and may be formed by a process, such as dipping or soldering. The metal layers 440 and 540 may include nickel (Ni), tin (Sn), copper (Cu), etc., and may be formed as a multilayer.

The coil 300 and the lead frames 400 and 500 according to the present disclosure may be bonded as follows.

The lead frames 400 and 500 and the coil 300 are prepared separately. Here, an insulating film formed on the lead wire may be removed in order to bond the coil to the lead frames 400 and 500. The lead wires 331 and 332 of the coil from which the insulating film has been removed may be rolled, and the lead wire of the rolled coil may have a rectangular cross-section as described above. In addition, a thickness of the rolled lead wires 331 and 332 may be 0.15 mm to 0.2 mm.

Thereafter, the lead frames 400 and 500 and the lead wires 331 and 332 are surface-bonded using a process, such as dipping and soldering, by using the metal layer. The bonded lead frames 400 and 500 and the lead wires 331 and 332 have a T-beam shape.

### Second Embodiment

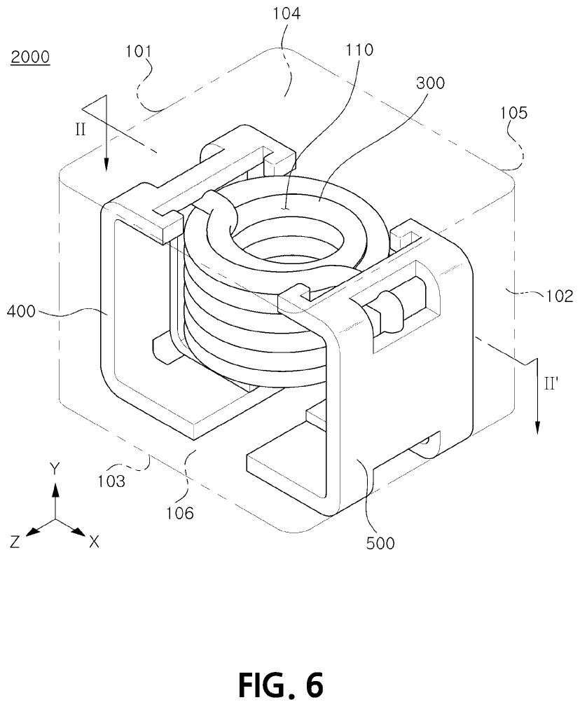

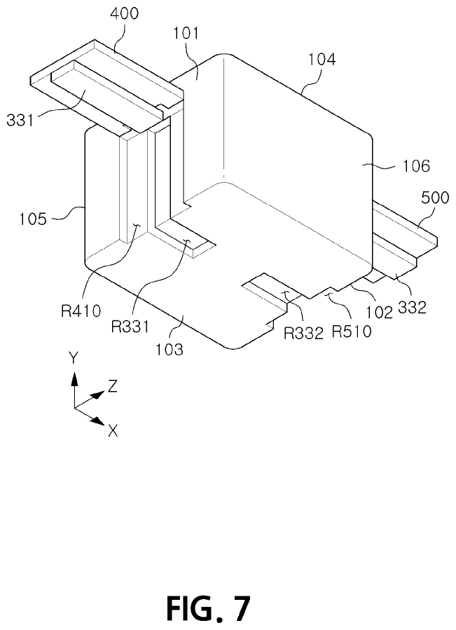

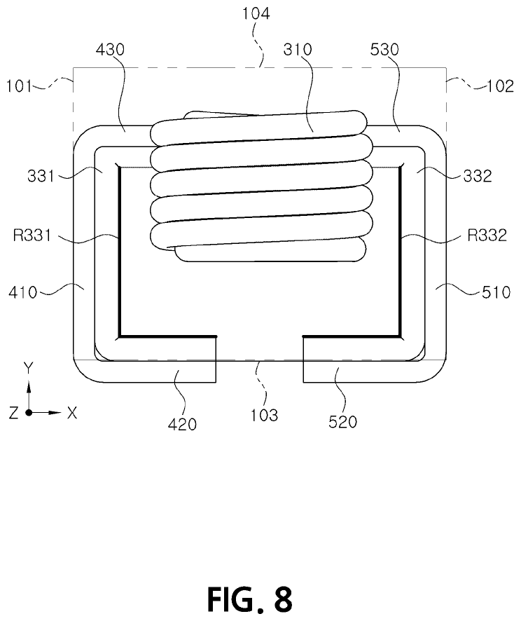

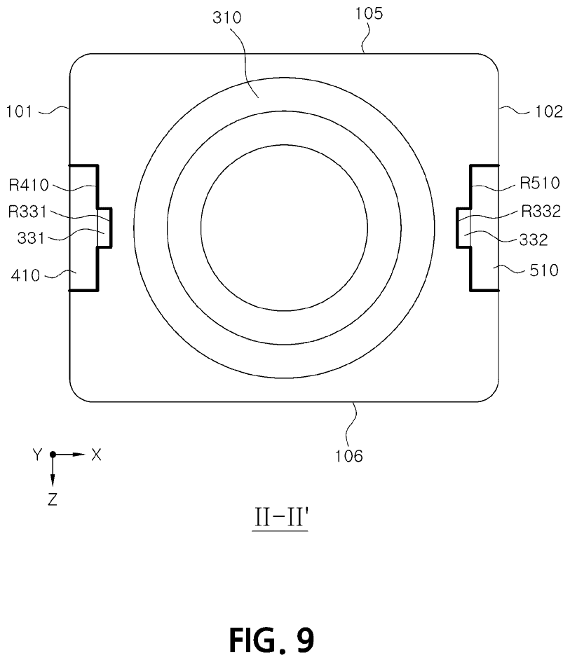

FIG. 6 is a perspective view illustrating a coil component according to a second embodiment of the present disclosure. FIG. 7 is a perspective view illustrating the body of FIG. 6. FIG. 8 is a view of the coil component of FIG. 6 as viewed in the Z-direction. FIG. 9 is a cross-sectional view taken along line II-II′ of FIG. 6.

A coil component 2000 according to the second embodiment has a different arrangement of the lead frames 400 and 500 compared to the first embodiment.

Hereinafter, the coil component according to the second embodiment will be described based on the differences compared to the first embodiment.

Referring to FIG. 7, the coil component 2000 according to the second embodiment may have a third recess R410 and a fourth recess R510 formed on the first surface 101 and the second surface 102 of the body to accommodate the lead frames 400 and 500.

Referring to FIGS. 8 and 9, at least a portion of the side surface portion 410 of the first lead frame may be disposed in the third recess R410. That is, the internal surface of the side surface portion 410 of the lead frame may be located on the inner side than the first surface 101 of the body 100. Similarly, at least a portion of a side surface portion 510 of the second lead frame may be disposed in the fourth recess R510. That is, the internal surface of the side surface portion 510 of the lead frame may be located on the inner side than the second surface 102 of the body 100.

Meanwhile, the external surface of the side surface portion 410 may be coplanar with the first surface 101 of the body 100.

Meanwhile, the third recess R410 and the fourth recess R510 may not be formed on the third surface 103 of the body 100. Accordingly, when mounting the coil component on a substrate, the lower surface portions 420 and 520 of the lead frame may protrude compared to the third surface 103 of the body in order to facilitate underfill.

The first recess R331 may be formed in the center of the third recess R410 and recessed inwardly from the third recess R410 into the body 100. Similarly, the second recess R332 may be formed in the center of the fourth recess R510 and recessed inward from the fourth recess into the body 100. As described above in the first embodiment, the lead wires 331 and 332 may be disposed in the first recess and the second recess R331 and R332.

The first lead frame 400 may not be disposed in the first recess R331. Similarly, the second lead frame 500 may not be disposed in the second recess R332.

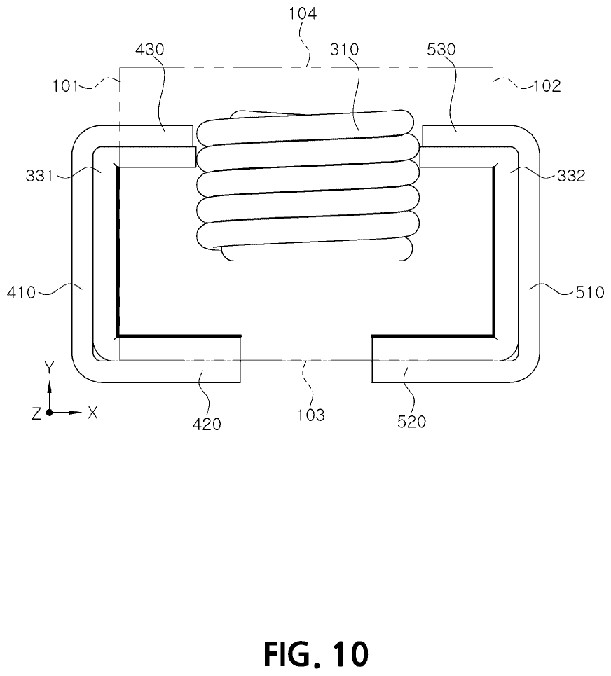

FIG. 10 is a diagram illustrating a modified example of FIG. 8.

Referring to FIG. 10, recesses may not be formed in the first surface 101 and the second surface 102 of the body of the modified example. Accordingly, the lead wires 331 and 332 may extend to the lower surface of the body along the side surfaces 101 and 102 of the body. Similarly, the side surface portions 410 and 510 of the lead frame may protrude from the side surfaces 101 and 102 of the body.

Descriptions of other components are the same as those of the first embodiment, and thus, are omitted.

### Third Embodiment

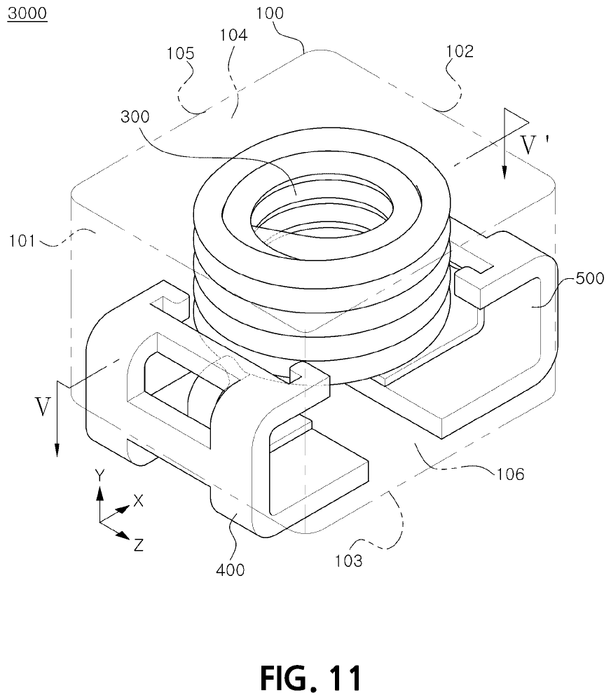

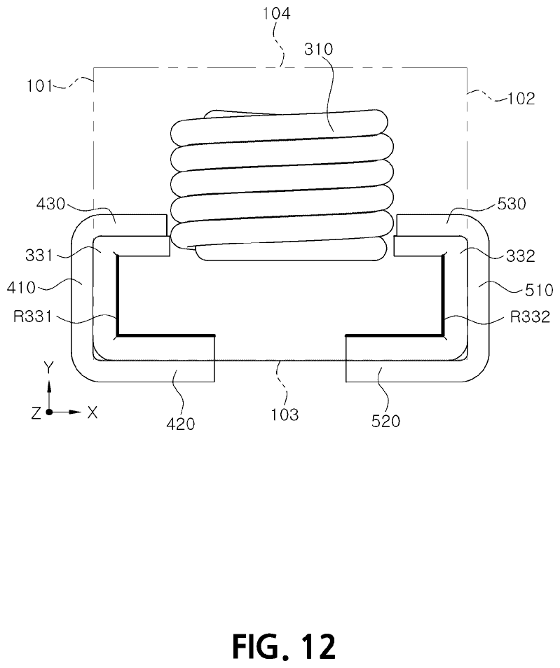

FIG. 11 is a perspective view illustrating a coil component according to the third embodiment of the present disclosure. FIG. 12 is a view of the coil component of FIG. 11 as viewed in the Z-direction.

Referring to FIG. 11, a coil component 3000 according to the third embodiment has different heights of lead wires 331 and 332 compared to the first embodiment.

The lead wires 331 and 332 of the coil component 3000 according to the third embodiment may be a low-center terminal structure formed in a region that is the same as or lower than a center line of the third surface 103 and the fourth surface 104 of the body in the second direction (the Y-direction).

Referring to FIG. 12, the lead wires 331 and 332 are disposed in the recesses R331 and R332 of the body, and the lead frames 400 and 500 protrude from the external surface of the body 100.

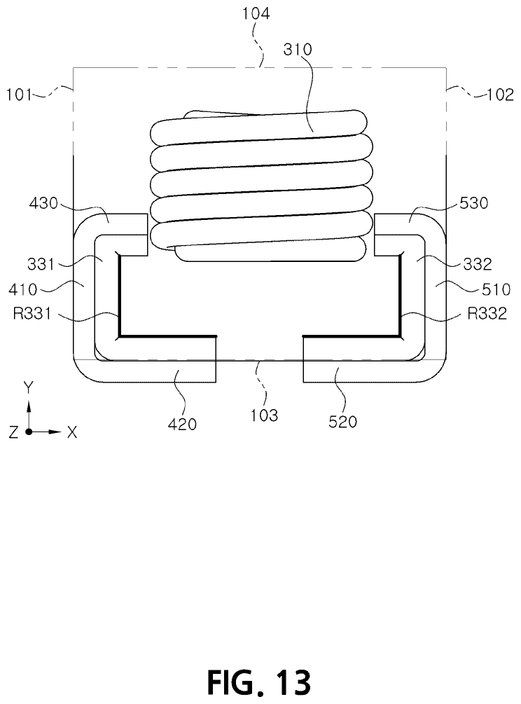

FIG. 13 is a diagram illustrating a modified example of FIG. 11.

Referring to FIG. 13, the side surface portions 410 and 510 of the lead frames 400 and 500 may be disposed on an inner side than the external surface of the body. As described above in the second embodiment, the recesses R410 and R510 for accommodating the lead frames 400 and 500 may be formed on the first surface 101 and the second surface 102 of the body.

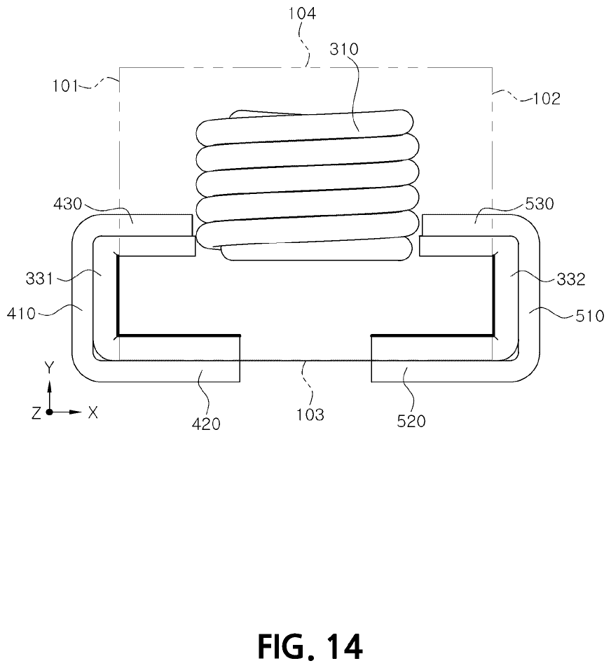

FIG. 14 is a diagram illustrating another modified example of FIG. 11.

Referring to FIG. 14, the first surface 101 and the second surface 102 of the body may not have recesses. Accordingly, the lead wires 331 and 332 may extend along the side surfaces 101 and 102 of the body to the lower surface of the body. Similarly, the side surface portions 410 and 510 of the lead frame may protrude from the side surfaces 101 and 102 of the body.

As one effect of the present disclosure, the coil component having improved electrical characteristics by minimizing loss of the volume of the magnetic body may be provided.

As one effect of the present disclosure, the coil component easy to secure bonding strength with a substrate when mounted on the substrate may be provided.

While example embodiments have been shown and described above, it will be apparent to those skilled in the art that modifications and variations could be made without departing from the scope of the present disclosure as defined by the appended claims.

What is claimed is:

1. A coil component comprising:
a body including a magnetic material, the body including a first surface and a second surface opposing each other in a first direction, a third surface and a fourth surface opposing each other in a second direction, and a fifth surface and a sixth surface opposing each other in a third direction, wherein at least one recess is formed in at least one of the first, second, third, or fourth surface;
a coil including a winding portion disposed within the body and at least one lead wire at least partially disposed in the at least one recess;
first and second lead frames disposed on the body, spaced apart from each other in the first direction and connected to the at least one lead wire,
wherein a ratio ‘a/b’ is 0.042 or more and 0.502 or less in which ‘a’ is an average length of the at least one recess in the third direction and ‘b’ is an average length of the first or second lead frame in the third direction.

2. The coil component of claim 1, wherein a is 0.21 mm or more and 2.51 mm or less.

3. The coil component of claim 1, wherein b is 1.8mm or more and 5.0 mm or less.

4. The coil component of claim 1, wherein the at least one recess includes a first recess and a second recess formed on the third surface of the body and spaced apart from each other in the first direction.

5. The coil component of claim 4, wherein the first recess extends to the first surface of the body, and the second recess extends to the second surface of the body.

6. The coil component of claim 1, wherein the at least one recess includes a first recess formed in the first surface of the body and a second recess formed in the second surface of the body.

7. The coil component of claim 1, wherein the first and second lead frames include internal surfaces facing the third and fourth surfaces of the body, respectively, and the at least one lead wire is in contact with the internal surfaces of the first and second lead frames.

8. The coil component of claim 7, wherein the internal surfaces of the first and second lead frames are coplanar with the third and fourth surfaces of the body, respectively, or are located outside the body.

9. The coil component of claim 1, wherein the first and second lead frames cover the at least one lead wire and are not disposed in the at least one recess.

10. The coil component of claim 1, wherein the first lead frame includes a side surface portion disposed on the first surface of the body and a lower surface portion disposed on the third surface of the body, and the second lead frame includes a side surface portion disposed on the second surface of the body and a lower surface portion disposed on the third surface of the body.

11. The coil component of claim 10, wherein:
the at least one recess includes a first recess formed in the first surface of the body and a second recess formed in the second surface of the body,
a third recess is formed on the first surface of the body,
a fourth recess is formed on the second surface of the body,
at least a portion of the side surface portion of the first lead frame is disposed in the third recess, and
at least a portion of the side surface portion of the second lead frame is disposed in the fourth recess.

12. The coil component of claim 11, wherein the first recess is formed in a center of the third recess and sunken inwardly of the body from the third recess, a second recess is formed in a center of the fourth recess and sunken inwardly of the body from the fourth recess, and at least a portion of the at least one lead wire is disposed in the first recess and the second recess.

13. A coil component comprising:
a body having at least one recess formed in one surface thereof, the body including a magnetic material;
a coil including a winding portion disposed within the body and a lead wire at least partially disposed in the at least one recess; and
at least one lead frame disposed on the one surface of the body, the at least one lead frame including an internal surface in contact with the lead wire and an external surface opposing the internal surface,
wherein the internal surface of the at least one lead frame is coplanar with the one surface of the body or is located outside the body.

14. The coil component of claim 13, wherein the at least one lead frame covers the lead wire and is not disposed in the at least one recess.

15. The coil component of claim 13, wherein
the body includes a first surface and a second surface opposing each other in a first direction, a third surface and a fourth surface opposing each other in a second direction, the at least one lead frame includes first and second lead frames spaced apart from each other in the first direction of the body, and the at least one recess is formed on the third surface of the body.

16. The coil component of claim 15, wherein:
the at least one recess includes a first recess and a second recess spaced apart from each other in the first direction on the third surface of the body,
the first recess extends to the first surface of the body, and
the second recess extends to the second surface of the body.

17. A coil component comprising:
a body including a magnetic material, the body including a first surface and a second surface opposing each other in a first direction, a third surface and a fourth surface opposing each other in a second direction, and a fifth surface and a sixth surface opposing each other in a third direction, wherein a first recess is formed on the first and third surfaces and a second recess is formed on the second and third surfaces;
a coil including a winding portion disposed within the body, and first and second lead wires extending from opposing ends of the winding portion in the first direction, bent and extending along the first and second recesses, respectively;
first and second lead frames disposed on the body, spaced apart from each other in the first direction and surface contacting outer surfaces of the first and second lead wires disposed in the first and second recesses, respectively,
wherein at least a portion of the first lead frame is disposed outside of the first surface, which is an outermost surface of the body, and at least a portion of the second lead frame is disposed outside of the second surface, which is another outermost surface of the body.

18. The coil component of claim 17, wherein the first lead frame includes an anchor portion embedded in the body and covering the first lead wire, and
the second lead frame includes an anchor portion embedded in the body and covering the second lead wire.

19. The coil component of claim 18, wherein a portion of the first lead wire is disposed in an inner groove of the anchor portion of the first lead frame, and
a portion of the second lead wire is disposed in an inner groove of the anchor portion of the second lead frame.

20. The coil component of claim 17, wherein each of the first and second lead frames includes an anchor portion embedded in the body, the anchor portion including at least one protrusion having an ‘L’ shape.

21. The coil component of claim 17, wherein each of the first and second lead frames comprises a side surface portion disposed on the first or second surface and a lower surface portion disposed on the third surface, and
the side surface portion includes an internal surface facing the first or second surface, and the internal surface of the side surface portion contacts the first and second lead wires.

22. The coil component of claim 21, wherein a portion of the first or second lead wire is disposed in a groove of the internal surface.
